(19) United States
(12) Patent Application Publication
(10) Pub. No.: US 2023/0392703 A1
(43) Pub. Date: Dec. 7, 2023

(54) IMPROVEMENTS RELATING TO VALVES

(71) Applicant: CHARGEPOINT TECHNOLOGY LIMITED, Liverpool, Merseyside (GB)

(72) Inventor: Mathew Carmichael, Liverpool, Merseyside (GB)

(73) Assignee: ChargePoint Technology Limited, Liverpool, Merseyside (GB)

(21) Appl. No.: 18/031,722

(22) PCT Filed: Oct. 12, 2021
(86) PCT No.: PCT/GB21/52631

§ 371 Date: Apr. 13, 2023

(51) Int. Cl. F16K 27/02; F16K 1/22

(52) U.S. Cl. CPC F16K 27/0218; F16K 1/223

(57) ABSTRACT

A valve having an active 10 and passive 12 valve portion that are complementarily shaped such that the passive 12 valve portion can be received by and mated with the active 12 valve portion. Each valve portion has a generally cylindrical valve body 14, 16 complementarily shaped with respect to one another such that the passive 12 valve portion may be received by the active 10 valve portion. Each valve portion has a valve closure member 18, 20 in the form of a circular planar disc rotatably mounted in the housing via means of one or more spindles, 22, 24 and 22′, 24′. The valve portions have a number of configurations whereby they can be partially engaged such that the valve portions may be separated to form a channel or chamber between valve closure members or fully engaged such that chamber or channel is closed such that the valve closure members are proximally disposed to one another and the valve may be opened or closed to permit the passage of material therethrough.

The present invention relates to valves, and in particular, but not exclusively, to valves for controlling, charging, discharging and/or regulating the flow of powders and/or fluids.

Valves, such as split butterfly valves, are available in many designs and used widely for processes where product containment is required to prevent product exposure to environment and personnel working in close proximity of the product. The split valves are designed pre-dominantly for handling and contained transfer of solid state powders and granular material alike.

Split valve design allows the valve to be split open into two halves, commonly called alpha and beta halves, or active and passive halves. The valve design is such that when split, the two halves keep the contents on either side sealed and contained.

Similar to the split butterfly valve, a split ball valve can also be used for contained transfer of solids and more commonly liquids. Historically, these valves have mainly been used in pharmaceutical and biotech industries for non-sterile operations.

In sterile equipment design, full systems need to be sterilised and once sterilised, it is important to ensure sterility is maintained throughout the processing cycle, for example, adding of materials, discharging of materials, any process transfers between systems etc.

Split valves can be sterilised via a number of known methods, which include autoclaving, passing steam through the open valve, or passing other gases, such as vapourised hydrogen peroxide, through them prior to any product coming in contact with the internal surfaces or product contact parts.

Unfortunately, when one of these conventional known valves is split, sterility is lost or compromised as some of the critical surfaces of the valve and seats, when split into two halves, become exposed to the outside surrounding non-sterile atmosphere. If the split valve is subsequently re-docked, and opened up for transfer of material, the entire system can lose sterility and result in product contamination.

In the manufacture of pharmaceuticals, chemicals or biological material, effective containment is essential for the safe and hygienic handling of such compounds and materials. At each stage of the manufacturing process, handling must be controlled and managed to provide optimum protection for the operator and for maintaining the integrity of the product.

The material being handled is often hazardous to health, owing to the increasing potency of many new active pharmaceutical ingredients (APIs). Pharmaceutical and bio-manufacturing products are often manufactured under strict controls against product contamination. This is because the products are often for human consumption and the industries are heavily regulated by bodies like the FDA (Food and Drug Administration) in the United States and the MHRA (Medicines and Healthcare products Regulatory Agency) in the United Kingdom. Furthermore, the APIs may, in sufficient quantities, be hazardous to the health of an operator. It is therefore necessary to avoid direct contact between an operator and the potentially hazardous material.

To avoid such direct contact, there is an increasing requirement to mount containment enclosures around process equipment. However, the design of such enclosures must minimise any hindrance to the operation of the equipment. When using a split valve assembly, this can become difficult for an operator to handle in such contained environments.

In addition, at the conclusion of each processing operation, the interior surfaces of the structure enclosing the processing zone must be thoroughly cleaned by the operator prior to a further processing operation to minimise the risk of cross-contamination. Consequently, the pharmaceutical manufacturing industry demands good containment performance to achieve acceptable operator exposure levels.

For handling a solid (e.g. powder) or liquid product of a sensitive or hazardous (e.g. toxic) nature in a processing zone, there are available a number of different types of containment assembly. One such conventional containment assembly is a barrier isolator with gloved access to the processing zone in which a product and/or handling equipment may be manipulated. A barrier isolator may offer two fold protection, namely the use of glove ports to maintain a physical barrier between the product and the operator and an extraction fan system to create an air flow for removing airborne particles from the processing zone and capturing the particles by means of filters. In this manner, a barrier isolator can achieve high containment typically down to nanogram level.

However, isolators designed for containment and sterility combined together, maintaining a sterile and sealed environment, both for the integrity of the material being handled and an operator's health, can be very expensive.

A known split butterfly valve that addresses these issues is provided by the Applicant and is described in WO2007107500 which discloses a valve assembly having two valve portions that are moveable between positions in which the valve portions are engaged but valve closure members disposed in each valve portion are held a distance apart for sterilising and in which the valve closure members are engaged and are able to move to open or close the valve. This system facilitates the transfer of material in a manner that avoids contamination from matter that may have been in contact with the valve closure members or portion of valve seat that is exposed when the valve closure member, the so-called ring of concern, is in its closed configuration.

When the valve portions are engaged, a locking ring maintains the valve portions in an engaged state and held a distance apart the system relies on gravity, manual manipulation, and/or springs to displace the valve portions to create the chamber between valve closure members through which sterilising medium may pass to ensure greater sterility. Typically, an operator will make use of the weight of the passive valve portion to facilitate the separation or else an operator will displace the valve portion themselves.

As a consequence, the volume of the chamber formed between valve closure members may fluctuate from one process cycle to another which renders the sterilising step in the process which comprises introducing a given volume of sterilising medium into the chamber and the process time required for satisfactory sterilisation difficult to accurately predict. The process cycle typically creates a negative pressure within the chamber, encouraging the volume to reduce. Consequently this step may excessively delay subsequent processing as operators over-compensate to ensure that the required sterility has been achieved.

Furthermore, the mechanism to displace the valve portions when engaged may unduly cause damage to processing equipment or else place unnecessary physical strain on an operator. A gradual controlled undocking to not disturb the sterilised environment or transferred powder would be advantageous.

It would also be advantageous if a valve system were physically smaller to be better accommodated within a processing environment.

Between material transfer steps, the active and passive valve portions can become contaminated from material and/or organisms in the surrounding environment, or from material being passed between valve halves in certain circumstances. Depending upon the level of sterility required by a process, extremely high in the manufacture of biologics, it may be necessary to clean the valve portions, particularly the valve closure plates, prior to and after material transfer to ensure that the material being transferred is not contaminated nor downstream processing steps when the valve halves are subsequently used.

To address this problem, it has been suggested to create a chamber between the valve halves just before and just after material transfer to clean or sterilise the outer surfaces of the valve closure plates to prevent contamination by whatever material or microorganisms are present on their surfaces.

However, there remains an issue with such mechanisms whereby the chamber created between the valve halves is rarely a constant volume, resulting in the need to use greater volume of sterilising medium than that which might be required to ensure that sterilisation occurs irrespective of the volume of the chamber. There is a need for repeatability and accuracy of formation of the chamber. In addition, there is little positive feedback to ensure that the chamber has been formed, nor in other configurations so as to provide feedback to an operator that the desired configuration has been achieved. Furthermore, when subjected to external forces, there remains a need to prevent inadvertent movement of the valve halves leading to misalignment or failure of the valve to open or close as desired.

In accordance with an aspect of the present invention, there is provided a split valve assembly, comprising a first valve portion and second valve portion, having displacement means for displacing the valve portions when they are engaged between discrete configurations comprising a first configuration wherein the valve portions are secured to one another such that they do not separate and the valve is open such that material may pass therethrough, and a second configuration wherein the valve portions are secured to one another but displaced from the first configuration to form a space therebetween and the valve is closed, wherein the displacement means comprises a mating pair, each valve portion comprising one member of the pair, and wherein the mating pair permits movement of the valve portions between the first and second configuration whilst the first and second valve portions are secured to one another.

The first and second valve portion may each comprise at least one cam or at least one cam follower. The at least one cam follower may be disposed on a first valve portion and the at least one cam may be disposed on a second valve portion.

The cam may comprise a cylindrical cam such that rotational displacement of the cam gives rise to linear displacement of the cam follower.

The linear motion of the cam follower may be parallel to the rotational axis of the cam. The cam may have a cam profile comprising a profiled groove or slot.

The valve may comprise a plurality of grooves or slots.

The cam profile may comprise at least two sections. One section may comprise an inclined ramp extending towards an apex; a second section may comprise a declined ramp, extending away from an apex. Rotation of the cam will cause the cam follower to be displaced away or toward the apex depending upon the direction of rotation which will have the effect of displacing the valve portion to which the cam follower is secured to be displaced away from or toward the other valve portion, creating or closing the space between valve halves.

In use a cam follower will be caused to be displaced in a plane perpendicular to the plane of rotation of the cam as it moves along the profile.

The cam will dictate the limit of displacement permitted for the creation of a chamber between valve closure members.

The first section may comprise a planar horizontal base, there is then a second, inclined section terminating at an apex, which then has a declined surface extending away from the apex.

The various sections may be selectively engaged by rotating the first valve portion about the second valve portion, or vice versa.

The cam follower may be received by a cam follower receiving member which retain the cam follower on three sides, two side walls and a base which support the cam follower and the valve portion to which it is attached through the transfer cycle and ensure that the cam follower is correctly engaged and in correct alignment prior to rotation of the cam and displacement of the valve between predetermined configurations.

The cam may be orientated around the longitudinal axis of the valve.

The cam may be open at one end, proximal to the first section to permit the cam follower to be received by the slot and the receiving member.

The cam may be rotatably mounted to a valve portion.

The system may comprise an actuator to rotate a valve portion relative to the other to move between configurations.

The cam may be rotatably connected to the main body by means of at least one fastener such that it can rotate but remain connected to the main body of the valve portion.

The main body may possess guides that are complementarily shaped to the cam follower and receive the cam follower when the valve portions are mated.

The guide prevents the cam follower from moving along the groove or slot unless the first portion is rotated.

In accordance with a further aspect of the present invention there is provided a split butterfly valve comprising a first and a second valve portion, said first and second valve portions capable of being mated to permit the passage of material therethrough wherein one valve portion has an axially disposed cam, the other having a cam follower for engagement with and co-operation with the axial cam such that rotational movement of the axial cam or the cam follower causes displacement of the other valve portion.

The axial cam is formed via two discrete components secured together. The first provides the upper limit of the axial cam whilst the second provides the lower limit. When secured together they provide a slot dimensioned to receive the cam follower and guide the cam follower on a path that will give rise to displacement of the cam follower and the valve portion to which it is attached.

The first valve portion may comprise one or more cams. Advantageously, the valve comprises three cams. The second valve portion may comprise a correspondingly number of cam followers.

The cams are disposed about the circumference first valve portion and the cam followers on the second valve portion are correspondingly disposed.

More advantageously, there are four cams and four cam followers.

Two of the cams are positioned proximally to one another with respect to the other two which are disposed equidistantly around the circumference of the valve.

The present invention may provide a mechanism that gives rise to accurate and reproducible configurations of the valve portions when mated to accurate control the various configurations and ensuring that the chamber formed between valve portions is consistent in volume. This assists in improving the sterilising step as a known volume of sterilising medium can be introduced for a given process step, which removes the necessity to use more sterilising medium or contact time than presently used as the chamber volume is difficult to accurately predict with known split butterfly valves and therefore to avoid potential issues, excessive volume of sterilising medium is used and the contact time is increased to be certain that sufficient sterilising has occurred. In the present invention, it will no longer be necessary to do this at the volume is more accurately predicted and reproducible enabling the specific volume of sterilising medium to be used for a given contact time. Therefore, processing can times can be better controlled and the cost of sterilising medium/impact used in the process is reduced as is the impact on manufacturing environment and resources minimised.

In accordance with the present invention, there is provided a split valve assembly comprising two valve portions complementarily shaped such that the first can sealingly engage with and co-operate with the second to allow the movement of material therethrough, each valve portion comprising a housing, a valve seat and a valve closure member moveable between a first position in which the valve closure member is displaced from the valve seat and the valve is open, and a second position in which the valve closure member co-operates with the valve seat and the valve is closed, wherein the assembly has a first configuration in which the first and second valve portions engage with one another, the valve closure members being closed, and the valve closure members being disposed a distance apart defining, with the housing, a chamber therebetween, which is capable of being sealed from the surrounding environment, and a second configuration in which the valve closure members engage with one another and are movable from their first to their second position, and a third configuration in which the two valve portions are disengaged from one another wherein one or more of the valve portions comprises means for selectively displacing one of the valve portions towards or away from the other whilst in an engaged configuration.

The means for displacing the valve portions may comprise the cooperation between one or more cams disposed on one valve portion and one or more cam followers disposed on the other valve portion.

The means for selectively displacing the one or more valve portions may comprise a upper and lower profiled surface between which the one or more locating pins may be located.

The one or more locating pins may extend perpendicularly to the central axis of the valve portion and movement of material through.

The profiled lower surface may comprise a first and second section that meet at an apex above which is a complimentarily shaped upper surface to accommodate a cam follower, and the valve portion with which it is associated, is displaced away from the other valve portion whilst in an engaged configuration. This may facilitate the controlled displacement of the valve portions to create a chamber between the valve closure members and through which sterilising medium may be capable of being passed. The chamber may have predetermined volume into which sterilising medium is capable of being introduced. The predetermined volume can be achieved on a repeatable basis as the displacement mechanism accurately controls displacement of the valve portion, and biases the cam followers, and the associated valve portion, towards or away from the other valve portion according to the profile of the profiled surface of the cam.

The assembly may have an inlet and an outlet through which sterilising medium may pass.

The inlet and/or outlet may be disposed in the first and/or second valve portion.

In a third configuration, the two valve portions are undocked, in the first configuration the two valve portions are engaged and the valve closure members separated and in the second configuration the two valve portions are completely docked such that the valve closure members may open or close to selectively open or close the valve.

The valve of the present invention is able to operate in a complete sterile manner, by use of an ‘in situ’ sterilisation step applied before completion of each docking (i.e. when in said first configuration), regardless of how many times the valve is split open and re-docked, i.e. engaged and disengaged, ensuring sterile conditions on product or material contact surfaces.

The present invention allows the valve to have a capability to have an intermediate stage during docking that allows a chamber which can be isolated from the surrounding environment to be formed between the surfaces which have been exposed to the atmosphere and which are not sterilised. These surfaces need to be sterilised before they can become exposed to the internal sterile parts of the assembly and material which may pass therethrough when the valve is fully docked and open so as to prevent contamination.

The present invention allows sterilisation to be maintained throughout the process of several product or material transfers, and is capable of allowing several dockings and un-dockings (engagement and disengagement), without compromising the sterility of the material to be transferred or internal process equipment upon which the valve portions of the present invention may be mounted. The chamber may also be cleaned using fluid gases or fluids before and after the sterilisation step, or in any sequence during the engagement/disengagement cycle, enabling the valve to be aseptic and under class A conditions without the need for sterile isolators or aseptic external environments.

Each valve portion of the assembly may be mountable on a vessel for containing material, conveyance means, such as a hose, for conveying material and/or other process equipment known to the art. The means for mounting the valve portions may comprise any means known to the art, such as for example a screw thread, interference fit, bayonet attachment etc. In an alternative embodiment, the valve portions may be integrally formed with a vessel or conveyance means.

The inlet and outlet of the chamber may be closed once the movement from the first to the second configuration is complete. In so doing, the assembly ensures that the material being transferred therethrough is not contaminated with sterilising medium.

The valve seat and valve closure member are preferably complementarily shaped to ensure that a seal is formed when the valve closure member is closed.

The valve assembly may be a split butterfly valve, split ball valve, any other split valve or quick release coupling known to the art. Preferably, the assembly is a split butterfly valve.

The inlet and/or outlet of the chamber may be formed in the housing of one of the valve portions. Preferably, both the inlet and the outlet are formed in the housing of one of the valve portions.

Preferably, the valve portions form a mating pair, one being a male valve portion, the other female. The inlet and/or outlet may be formed in the housing of one or both of the valve portions. More preferably, the inlet and outlet for the chamber is formed in the female valve portion.

In one embodiment, the chamber has circular cross section.

In an embodiment, the inlet and outlet is radially disposed with respect to the chamber.

The valve assembly may comprise a plurality of inlets and outlets through which sterilising medium may pass. Preferably, the number of inlets corresponds directly to the number of outlets. More preferably, the assembly comprises one inlet and one outlets. Where the chamber has a circular cross section, the inlet and outlet are preferably disposed diametrically opposite one another about the circumference of the chamber

The valve closure member may be pivotally mounted within the valve housing by means of opposed spindles projecting from the closure member and located in corresponding recesses within the valve housing. The valve housing may be provided with a valve seat and the valve closure member can be pivotable into and out of engagement with the valve seat to close and open the valve respectively. Preferably, the spindles are integrally formed with the valve closure member. Advantageously, the spindles and the valve closure member, may be machined from a single piece of material.

Preferably, the valve seat comprises a seal member. The seal member may preferably comprise an abutment portion and a resiliently deformable portion, such as a O-ring, located between the abutment portion and the valve housing.

In an alternative embodiment, the valve closure member may be provided with a recess for receipt of a seal which, in use, is adapted to engage against a solid portion of the valve housing.

In the case where the seal is located in a recess in the valve closure member the valve closure member may further comprise an elastomeric material covering the valve closure member and the seal located thereon.

The valve seal may be located either on the valve housing or on the valve closure member.

In order to ensure that the chamber, defined by the housing of one or both of the first and second valve portions and the valve closure members, is capable of being sealed from the surrounding environment, an O ring and/or inflatable seal may be disposed on the housing of one or both of the valve portions. This ensures that during cleaning, whereby sterilising medium is passed through the chamber when the assembly is in its first configuration and when material is transferred through the valve there is a significantly reduced possibility of cross-contamination between the chamber and the surrounding environment, thus ensuring that the material transferred is not contaminated and maintaining operator safety.

The sterilising medium suitable for use with the assembly of the present invention may comprise a fluid, vapour and/or gas. Preferably, the medium is vaporised hydrogen peroxide, filtered nitrogen, filtered air and/or water. For materials sensitive to heat, vaporised hydrogen peroxide is preferably used, whilst for materials not generally heat sensitive, steam under pressure can be used. Pressurised and filtered air and/or nitrogen or other such gases may be used as a cleaning medium to blow any debris, particles, residues, impurities etc. out of the chamber in lieu of or in combination with other sterilising media. If it is to be used as a sterilising medium, then the aim is preferably filtered to remove potential contaminants.

The outlet may be connected to filter means and/or a catalyst to treat any waste stream from the chamber.

During use, the assembly may be switched from the first to the second configuration to allow material to be transferred therethrough. Once the material has been transferred, the assembly is switched back to the first configuration and the surfaces which are to be exposed to the surrounding environment cleaned before disengaging the two valve portions so as to prevent the operator from being exposed to any residual material left on the exposable surfaces, and thus ensuring operator safety.

In accordance with an aspect of the present invention, there is provided a locking ring for a split valve having a first and second valve portion having discrete configurations in which the position of each valve portion relative to one another may change, wherein the locking ring comprises a slot for receiving the locating pin of one valve portion communicating with a profiled guide slot in which the locating pin is received for displacing the locating pin and thus the associated valve portion between discrete configurations with respect to the other valve portion.

In accordance with a further aspect of the present invention, there is provided a method of moving a material from one vessel to another without exposing the material to the surrounding environment comprising the use of a valve assembly as described hereinabove, the method comprising the steps of:
a) Engaging or securing the valve portions such that the assembly conforms to its first configuration;
b) optionally cleaning the chamber;
c) sterilising the chamber;
d) displacing the valve portions such that the assembly conforms to its second configuration;
and
e) opening the valve to allow the movement of material therethrough.

Once the requisite quantity of material has been transferred, the method may also comprise the subsequent steps of:
f) displacing the valve portions such that the assembly conforms to its first configuration;
g) optionally cleaning the chamber;
h) optionally sterilising the chamber; and
i) disengaging the valve portions.

In accordance with a further aspect of the present invention, there is provided a split valve comprising a first and second valve portion, each having a housing having a valve closure member and a valve seat, wherein the valve seat is retained between the housing and a releasably securable valve seat retaining member.

The valve seat retaining member may comprise a cover plate securable to the housing and between which is located the valve seat in use.

The cover plate may be releasably secured to the housing via fastening means. The fastening means may comprise one or more fastening members. The fastening member may comprise a bolt with a threaded shaft. The housing may comprise complementarily shaped threaded bores to receive the threaded shaft of the fastening member.

The cover plate may be a planar circular body having a centrally disposed aperture sized to correspond to the diameter of the valve closure member such that the valve closure member may rotate to open the valve portion and be accommodated within the aperture of the cover plate

Extending around the aperture and set a distance from the edge of the aperture may be a circumferential upstanding wall which serves to help retain the valve seat in place when assembled.

The valve seat has a cylindrical body having a circumferential flange around one end and two cut outs in the side wall at the other end, diametrically spaced apart and semi-circular in profile. The cut outs accommodate the spindles which open and close the valve closure members.

It is the flange that is accommodated by the upstanding wall and the circumferential edge of the flange abuts against the upstanding wall retaining the valve seat in position.

To replace a valve seat, rather than the valve seat having to be manufactured from a deformable material, more prone to wear and tear, the valve seat may be manufactured from a more resilient material and does not need to have the great flexibility found in known valve seats to facilitate easier replacement. Instead, the cover is removed by loosening and removing the fastener means and the valve seat simply displaced without having to deform its shape.

The need to deform the shape of the valve seat also makes replacement more difficult for an operator as they are required to deform the shape whilst ensuring that the cut outs overlie the spindle shafts so that the seat is correctly aligned and will not fail. No need for use of tool to prise the seat out of place or locate the seat in place.

The present invention dispenses with the need for this feature in the valve seat and the associated difficulty with the method of replacement currently employed. Rather the present invention permits a valve seat to be simply removed and then replaced in correct alignment in a straightforward manner by providing a valve portion having a housing having a removable cover to expose the channel in which the flange is received of the valve seat.

Specific embodiments of the present invention will now be described by way of example only, in which:

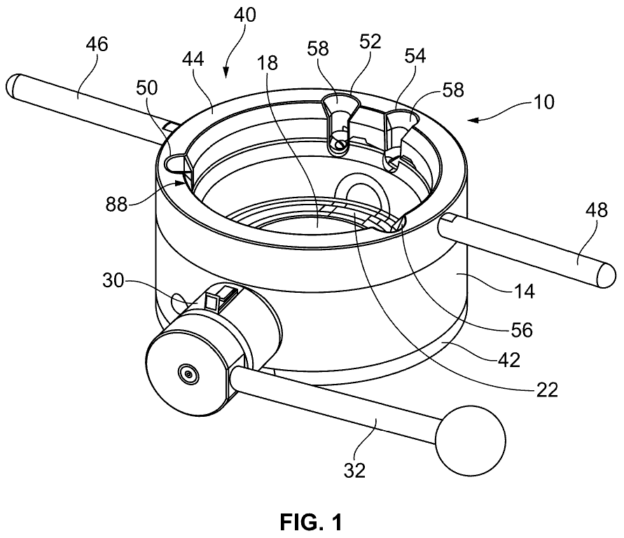

FIG. 1 shows an active valve portion in accordance with the present invention;

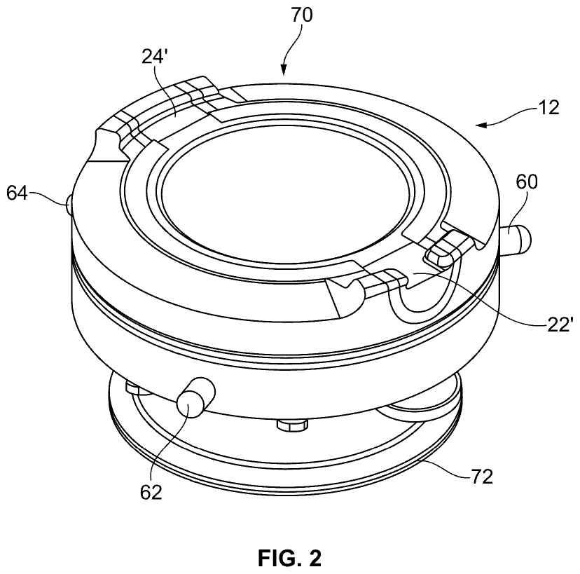

FIG. 2 shows a passive valve portion in accordance with the present invention;

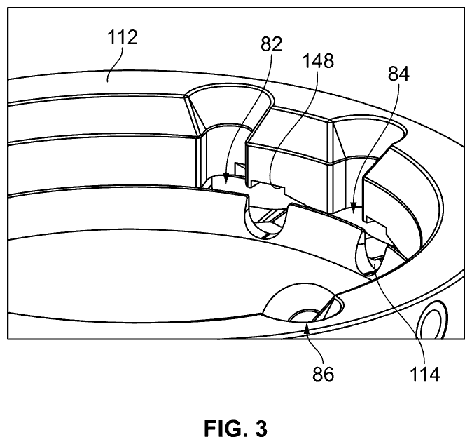

FIG. 3 is an enlarged view of the active valve portion in accordance with the present invention;

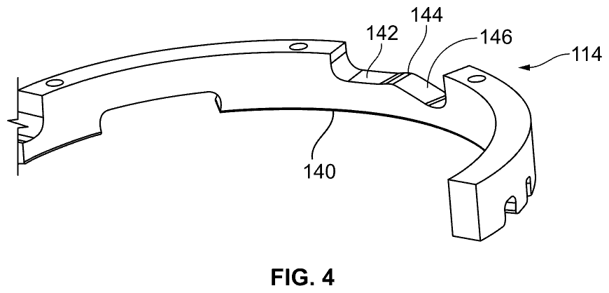

FIG. 4 is an enlarged view of a displacement means or cam in accordance with the present invention;

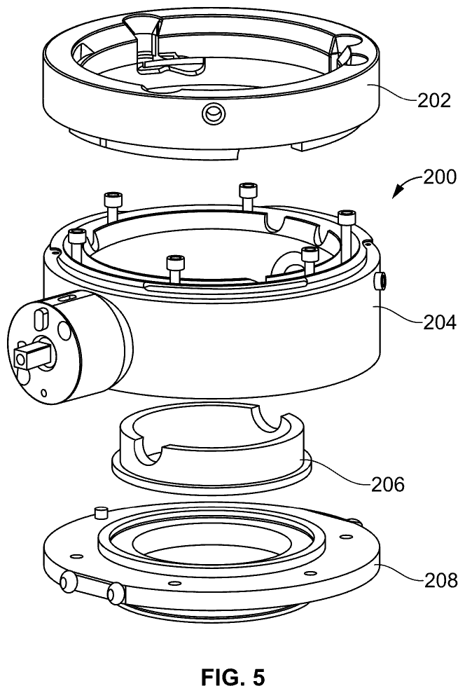

FIG. 5 shows an exploded view of a valve portion in accordance with the present invention;

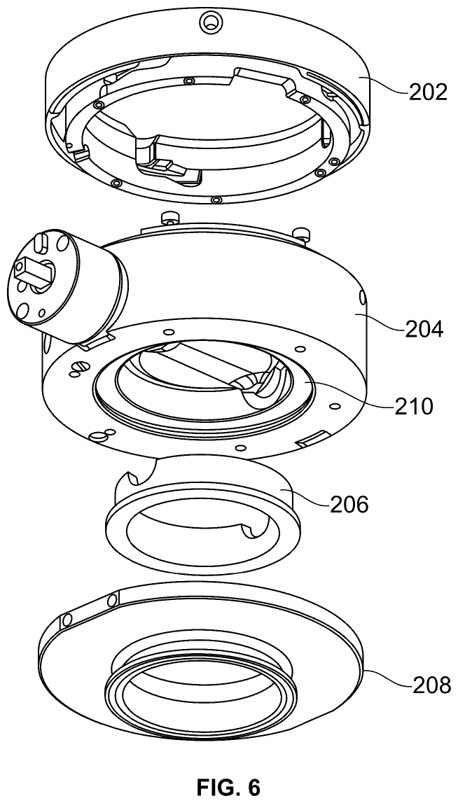

FIG. 6 shows the exploded view of FIG. 5 from below;

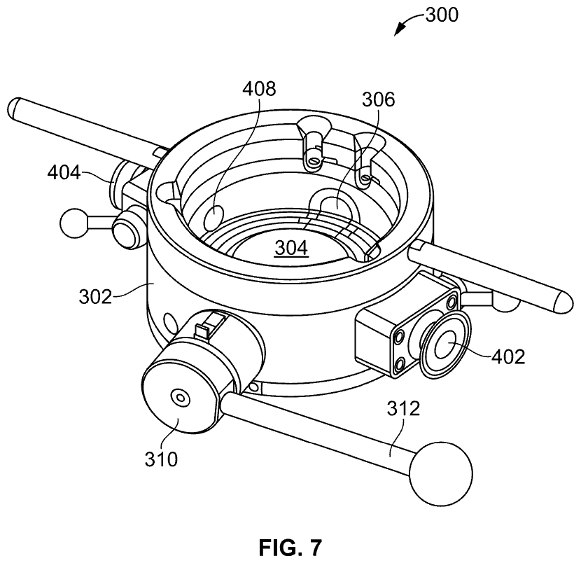

FIG. 7 shows an active valve portion in accordance with the present invention

There is shown a split butterfly valve having an active 10 (see FIG. 1) and passive 12 (see FIG. 2) valve portion that are complementarily shaped such that the passive 12 valve portion can be received by and mated with the active 12 valve portion. Each valve portion has a generally cylindrical valve body 14, 16 complementarily shaped with respect to one another such that the passive 12 valve portion may be received by the active 10 valve portion. Each valve portion has a valve closure member 18, 20 in the form of a circular planar disc rotatably mounted in the housing via means of one or more spindles, 22, 24 and 22′, 24′. The valve portions have a number of configurations whereby they can be partially engaged such that the valve portions may be separated to form a channel or chamber between valve closure members or fully engaged such that chamber or channel is closed such that the valve closure members are proximally disposed to one another and the valve may be opened or closed to permit the passage of material therethrough.

The active valve portion 10 has an actuator 30, operatively connected to a lever 32 and the valve closure members 18 and 20, that is capable of causing the valve closure members to rotate about their spindles to selectively open or close the valve when the valve portions are mated.

FIG. 1 shows an active valve portion 10 in accordance with the present invention having a generally cylindrical body open at one end 40 and selectively closable at the other end 42.

Rotatably mounted at the open end 40 is a circular locking ring 44 having two radially extending handles 46, 48 disposed diametrically opposite one another. The handles permit a user to manually rotate the locking ring. Alternatively, the locking ring could be driven by a motor (not shown).

There are four guide slots 50, 52, 54, 56 disposed around the internal circumference of the locking ring having a semi-circular side wall with a chamfered open end 58, each shaped to receive a complementarily shaped pin 60 extending radially from the valve portion body 16 and having a rounded free end 62.

FIG. 2 shows the passive valve portion 12 having a generally cylindrical valve body being selectively closable at one end 70 by valve closure member 20 and open at the other end 72. The open ends of the valve bodies are connectable to other processing equipment such as conduits for delivering or conveying away material to be transferred, for example.

The guide slots 52, 54, 56, 58 extend longitudinally with respect to the axial axis of the locking ring and each communicate with a profiled slot 82, 84, 86, 88 (FIG. 3) which extend around the internal circumference of the locking ring and which form part of a cam mechanism disposed within the locking ring 44. The cam mechanism comprises the co-operation between the pins 60, 62, 64, 66 (not shown) which form the cam follower and the cylindrical cam provided by the four profiled slots 82, 84, 86 and 88. Rotation of the locking ring around the longitudinal axis of the valve body gives rise to linear displacement of the cam follower and thus the passive valve portion to which it is connected in a direction parallel to the rotational axis of the locking ring in which the cam is disposed. This mechanism provides for the displacement of the valve portions between their partially and fully engaged configurations.

The locking ring 110 is formed by an upper 112 and lower ring 114 member secured to one another. The locking ring has four profiled slots 82, 84, 86, 88 each associated with and communicating with a guide slot 52, 54, 56, 58 respectively. The guide slots are profiled and shaped to receive the pins, the chamfered opening facilitating easy location of the pins and thus the passive valve portion.

FIG. 4 shows the lower ring member 114 of the locking ring. Each guide slot has a lower and upper surface. The lower surface is profiled and has three sections: a first flat section 142 parallel to the plane of the base 140 of the locking ring; a ramp section 144; and a third declined section 146. The upper surface of the guide slot also has a complimentarily shaped profile to that of the lower surface such that between them they are dimensioned to accommodate and guide a locating pin which functions as the cam follower. The upper ring member has a cut out 148 that is in alignment with the apex of the ramp section and declined section of the lower ring member of the guide slot. When a locating pin is received by the guide slot it is able to follow the profile and be displaced according to the profile of the slot.

When the valve portions are mated, the locating pins 34-40 are received by the slots 112-118. The locking ring is rotated using the radially extending handles 160′, 160″ anti-clockwise to bring the second portion of the profiled lower surface of the locking ring to overlie the locating pins. The second section of the lower profiled surface of the guide slot urges the valve passive valve portion and thus the valve closure member of the passive away from the valve closure member of the active valve portion to separate them in the partially engaged configuration. A chamber is formed between the valve closure members. Sterilising medium may then pass through the chamber. The locking ring is then further rotated anti-clockwise to engage the third portion of the profiled lower surface of the locking ring guide slot which urges the locating pins and thus the valve closure members towards one another to enable the engaged configuration to be adopted. The valve may then be opened. The operation does not require the operator to force the valve portions apart when partially engaged nor does the mechanism rely on gravity but rather a controlled movement by rotating the locking ring.

In addition, since the locating and locking mechanism is performed by the co-operation of the locating pins on the passive valve portion and the slots and guide slots of the locking mechanism of the locking ring of the active valve portion, the mechanism is more discrete and there are no holes or recesses exposed once the valve portion are engaged improving the GMP of the valve. Furthermore, the volume of sterilising medium needed in each sterilising or cleaning cycle can be accurately controlled as the volume of the chamber between the valve closure members in the partially engaged configuration can be more easily calculated and relied upon. The guide track ensures that movement between each discrete configuration is accurately controlled.

FIG. 5 shows an exploded view of an active valve portion in accordance with the present invention. The active valve portion 200 has a locking ring 202, a generally cylindrical housing 204, an annular valve seat 206 and a valve seat cover 208.

FIG. 6 shows FIG. 5 from below and a recessed annular support 210 for receiving and engaging with a circumferential lip 212 extending around the valve seat 206.

Presently, valve seats are elastically deformable so as to enable replacement. However, they require significant deformation to insert and subsequently replace which requires less abrasion resistant materials to be used and furthermore requires significant down time when a valve seat requires replacement whilst an engineer attempts to correctly align and replace.

The present invention provides an end cover releasably securable to the housing of the active and/or passive valve portion that enables access to the valve seat receiving chamber. As a consequence, the valve seat requires little or no deformation to and therefore insert better suited materials to prolong valve seat life can be used for their manufacture.

In addition, when replacing worn valve seats, an operator can quickly and more reliably correctly align the valve seat in the apparatus, reducing down-time when the valve in unable to be used.

FIG. 7 shows an active valve portion 300 in accordance with the present invention. The valve portion has a generally cylindrical housing 302 having a valve closure member 304 in the form of a circular planar disc rotatably mounted in the housing via means of spindles 306 and 308 (not shown).

An actuator 310 associated with an active valve portion operatively connected to a lever and the valve closure member is capable of causing the valve closure member to rotate about the spindles to selectively open or close the valve when the valve portions are mated.

The passive and active valve portion of the present invention is much more compact than known passive valve portions and has fewer surfaces to clean, and maintain to GMP standards.

The active valve portion 300 having a port 402, 404 disposed diametrically opposite one another and extending radially from the housing body 302 in a plane perpendicular to the central axis of the valve portion member. The ports 402 and 404 communicate with the interior of the valve portion and the chamber is capable of being formed between active and passive in certain configurations via inlet and outlet 408, 410 (not shown).

The inlet and outlet are cylindrical through going bores in the housing 302 that are radially disposed with respect to the chamber and extend in a plane perpendicular to the central axis of the housing body.

1. A split valve assembly, comprising a first valve portion and second valve portion, having displacement means for displacing the valve portions when they are engaged between discrete configurations comprising a first configuration wherein the valve portions are secured to one another such that they do not separate and the valve is open such that material may pass therethrough, and a second configuration wherein the valve portions are secured to one another but displaced from the first configuration to form a space therebetween and the valve is closed, wherein the displacement means comprises a mating pair, each valve portion comprising one member of the pair, and wherein the mating pair permits movement of the valve portions between the first and second configuration whilst the first and second valve portions are secured to one another.

2. An assembly as claimed in claim 1 wherein the first and second valve portion each comprise at least one cam or at least one cam follower.

3. An assembly as claimed in claim 2 wherein
the at least one cam follower is disposed on a first valve portion,
the at least one cam is disposed on a second valve portion,
the at least one cam comprises a cylindrical cam with a cam profile comprising a plurality of profiled grooves or slots.

4. (canceled)

5. (canceled)

6. (canceled)

7. An assembly as claimed in claim 3, wherein the cam profile further comprises:
at least two sections, wherein a first section of the cam profile comprises an inclined ramp extending towards an apex; and, a second section comprises a declined ramp, extending away from the apex.

8. (canceled)

9. An assembly as claimed in in claim 7, wherein:
the cam follower is displaced in a plane perpendicular to the plane of rotation of the cam as it moves along the profile,
the cam follower is received by an alignment member to ensure that cam follower is in correct alignment prior to rotation of the cam and the displacement of the valve portions between configurations, and
the groove or slot is open at one end, proximal the first section to permit the cam follower to be received.

10. (canceled)

11. (canceled)

12. (canceled)

13. An assembly as claimed in claim 12 further comprising a valve portion and an actuator to rotate the valve portion, wherein the cam is rotatably mounted on the valve portion such that it can rotate but remain connected to the main body of the valve portion.

14. (canceled)

15. An assembly as claimed in claim 13 wherein the valve portion further comprises one or more guides that are complementarily shaped to the cam follower and receive the cam follower when the valve portions are mated, and the one or more guides prevents the cam follower from moving along the groove or slot unless the valve portion is rotated.

16. (canceled)

17. A split butterfly valve comprising a first and a second valve portion, said first and second valve portions capable of being mated to permit the passage of material therethrough wherein one valve portion has an axially disposed cam, the other having a cam follower for engagement with and co-operation with the axial cam such that rotational movement of the axial cam or the cam follower causes displacement of the other valve portion.

18. A valve as claimed in claim 17, wherein the axial cam is formed via two discrete components secured together, the two discrete components comprising a first and second component when secured together provide a slot dimensioned to receive the cam follower and guide the cam follower on a path that will rise to displacement of the cam follower and the valve portion wo which it is attached.

19. (canceled)

20. A valve as claimed in claim 18, wherein the first valve portion comprises one or more cams.

21. (canceled)

22. A valve as claimed in claim 20 wherein the second valve portion comprises a correspondingly number of cam followers.

23. A valve as claimed in claim 22, wherein the cams are disposed about the circumference first valve portion and the cam followers on the second valve portion are correspondingly disposed.

24. A valve as claimed in claim 17 where in two valve portions are complementarily shaped such that the first can sealingly engage with and co-operate with the second to allow the movement of material therethrough, each valve portion comprising a housing, a valve seat and a valve closure member moveable between a first position in which the valve closure member is displaced from the valve seat and the valve is open, and a second position in which the valve closure member co-operates with the valve seat and the valve is closed, wherein the assembly has a first configuration in which the first and second valve portions engage with one another, the valve closure members being closed, and the valve closure members being disposed a distance apart defining, with the housing, a chamber therebetween, which is capable of being sealed from the surrounding environment, and a second configuration in which the valve closure members engage with one another and are movable from their first to their second position, and a third configuration in which the two valve portions are disengaged from one another wherein one or more of the valve portions comprises means for selectively displacing one of the valve portions towards or away from the other whilst in an engaged configuration.

25. A valve as claimed in claim 24 wherein:
the means for displacing the valve portions comprises the cooperation between one or more cams disposed on one valve portion and one or more cam followers disposed on the other valve portion, and
the means for selectively displacing the one or more valve portions comprises an upper and lower profiled surface between which one or more location pins are located, the one or more locations pins extending perpendicularly to the central axis of the valve portion and movement of material through.

26. (canceled)

27. (canceled)

28. A valve as claimed in claim 24 wherein
the lower profiled surface comprises a first and second section that meet at an apex above which is a complimentarily shaped upper surface to accommodate a cam follower, and the valve portion with which it is associated, is displaced away from the other valve portion whilst in an engaged configuration, and
the split valve assembly further comprises an inlet and an inlet through which a sterilizing medium may pass.

29. (canceled)

30. (canceled)

31. A valve as claimed in claim 28 having a third configuration, the two valve portions are undocked, in the first configuration the two valve portions are engaged and the valve closure members separated and in the second configuration the two valve portions are completely docked such that the valve closure members may open or close to selectively open or close the valve.

32. (canceled)

33. A valve as claimed in claim 24, the valve further comprising a locking ring, the locking ring comprising a first and second valve portion having discrete configurations in which the position of each valve portion relative to one another may change, wherein the locking ring comprises a slot for receiving the locating pin of one valve portion communicating with a profiled guide slot in which the locating pin is received for displacing the locating pin and thus the associated valve portion between discrete configurations with respect to the other valve portion.

34. A method of moving a material from one vessel to another without exposing the material to the surrounding environment comprising the use of a valve assembly as described hereinabove, the method comprising the steps of:
a) Engaging or securing the valve portions such that the assembly conforms to its first configuration;
b) optionally cleaning the chamber;
c) sterilizing the chamber;
d) displacing the valve portions such that the assembly conforms to its second configuration; and
e) opening the valve to allow the movement of material therethrough.
f) displacing the valve portions such that the assembly conforms to its first configuration;
g) optionally cleaning the chamber;
h) optionally sterilizing chamber; and
i) disengaging the valve portions.

35. (canceled)

36. A valve as claimed in claim 24 each of the first and second valve portions having a housing having a valve closure member and a valve seat, wherein the valve seat is retained between the housing and a releasably securable valve seat retaining member.

37. A valve as claimed in claim 36 wherein the valve seat retaining member comprises a cover plate releasably secured to the housing and between which is located the valve seat in use, wherein the cover plate comprises a planar circular body having a centrally disposed aperture sized to correspond to the diameter of the valve closure member such that the valve closure member may rotate to open the valve portion and be accommodated within the aperture of the cover plate.

38. (canceled)

39. (canceled)
